(19) United States
(12) Patent Application Publication
(10) Pub. No.: US 2021/0170515 A1
(43) Pub. Date: Jun. 10, 2021

(54) WELDING AUTOMATION SYSTEM USING SHAPE OF WELDING REGION AND MEASUREMENT OF 3D COORDINATES, AND WELDING METHOD USING SAME

(71) Applicant: Sung Kyu OH, Gimpo-si (KR)

(72) Inventor: Sung Kyu OH, Gimpo-si (KR)

(21) Appl. No.: 16/768,664

(22) PCT Filed: Nov. 30, 2018
(86) PCT No.: PCT/KR2018/015157

§ 371 Date: May 30, 2020

(30) Foreign Application Priority Data
Nov. 30, 2017 (KR) 10-2017-0163580

(51) Int. Cl. B23K 9/095; B23K 9/127; B23K 9/24

(52) U.S. Cl. CPC B23K 9/0956; B23K 9/24; B23K 9/1274; B23K 9/0953

(57) ABSTRACT

A welding automation system that uses the shape of a welding region includes a welding torch that is installed in a robot and welds a parent metal fixed on a mounting part. A line laser emits a laser beam to a welding line region that is spaced apart from a welding point of the welding torch. A detector images and detects, from a predetermined angle, the shape of the laser beam. A control unit receives information from the detector and controls transportation of the robot and drives the welding torch along the welding region so that the welding torch corresponds with the welding region. The welding torch is installed on a slider that moves vertically and laterally relative to the robot. The control unit controls movement of the robot and/or the mounting part to correspond to transportation coordinates obtained by the calculation unit, and controls driving of the welding torch.

### TECHNICAL FIELD

The present invention relates to a welding automation system using a shape of a welding region and 3D coordinate measurement, and a welding method using the same, and more specifically, to a welding automation system using a shape of a welding region and 3D coordinate measurement, and a welding method using the same, which can adjust a welding position of a welding gun, determine a welding start position and reduce the possibility of measurement error for a deflection point as well as can quickly correct the welding defects by comparing 3D coordinate measurement data, which is obtained by detecting the shape of the welding region using a line laser, with image data that is previously provided.

### BACKGROUND ART

In general, welding work is facing the labor shortage and aging due to poor working environment. In order to solve these problems, automation of production technology that can replace human resources is required.

To make the automation of the above-described welding process, it is necessary to accurately track a welding line and measure a volume of the welding region to perform proper welding.

In this regard, among techniques related to the tracking of welding line, Korean Unexamined Patent Publication No. 10-2009-0055278 (hereinafter referred to as ‘related art’) discloses a technique in which a line laser emits a laser beam along a welding line, a reflected shape of the line laser for the welding region is detected to calculate a shape of the welding region and a volume of the welding region and the shape and the volume are applied to the welding working.

The related arts including the above-mentioned related art is to perform the welding work while moving a welding torch to the welding region depending on the detection data of the welding region. However, the position of the welding start point for the target is checked by a worker through a video image. Thus, when the welding work is performed with respect to multiple targets, working time is increased due to the operation of confirming each start position, and the accuracy is deteriorated.

In addition, among the related arts, there are cases in which targets to be welded to each other are spot welded. The spot welding region may cause welding defects, such as a change in the properties of the welding region, due to the double welding. In addition, the flash generated during the welding process including the secondary welding at the spot welding region affects the reflected light of the line laser, causing errors in shape data.

Further, depending on the related arts, it is difficult to confirm whether the welding has been normally performed on the welding region of a wide area. In addition, the inspection may rely on confirmation work of the worker after completing the welding work.

Furthermore, depending on the related arts, contact resistance between a welding rod and a parent metal becomes high when there is paint or rust on the parent metal so that starting current is not generated, thereby causing the welding defects due to the failure in starting the welding or instable current. In order to solve the above problem, the welding work is performed without reflecting corrections, but the same or similar welding defects are repeated.

After all, it is necessary to perform the welding work again after confirming the welding defects. However, the inspection time after completion of the primary welding work, and the progress of the welding work to solve the welding defects after the inspection has been completed may increase the working time and cause uneconomical problems.

(Patent Document 0001) Korean Unexamined Patent Publication No. 10-2009-0055278 (published on Jun. 2, 2009)

### DETAILED DESCRIPTION OF THE INVENTION

### Technical Problem

Therefore, the present invention is suggested to solve the above-mentioned problems, and an object of the present invention is to provide a welding automation system using a shape of a welding region and measurement of 3D coordinates, and a welding method using the same, capable of matching preset shape data with shape data of a detected welding region, in which a welding start position of each target is reflected to a welding work such as an inflection point and a welding end point of the welding, so that the welding accuracy is improved and the working time is reduced, it is possible to prevent errors in shape detection of the welding region in response to the flash generated during the welding process, and the reliability of the welding work is improved by making it possible to perform the welding correction work based on the determination of the normality of the welding region where the welding work was performed and the confirmation of the welding defects.

### Technical Solution

In order to achieve the above objects, depending on the present invention, there is provided a welding automation system using a shape of a welding region and 3D coordinate measurement, the welding automation system including: a welding torch installed in a robot to weld a parent metal fixed on a mounting part depending on a control signal; a line laser for emitting a laser beam having a straight line shape to a welding line region which is spaced apart from a welding point of the welding torch; a detector for imaging and detecting the shape of the line-shaped laser beam emitted to a welding target region at a preset angle; and a control unit for receiving information from the detector to control transportation of the robot and driving of the welding torch along the welding region such that the welding torch corresponds to the welding region, wherein the welding torch is installed on a slider which is driven in upward, downward, left, and right directions with respect to the robot, the control unit includes: a database for storing preset shape information on a welding start point region and a welding end point region of the parent metal; and a calculation unit for determining whether welding region shape information received from the detector matches the preset shape information in the database, while obtaining a welding condition including transportation coordinates of the welding torch, a welding depth, a welding width, a welding amount, and a welding time such that the welding torch corresponds to the welding region shape information of the detector at a preset interval, and the control unit controls a movement of the robot and/or the mounting part to correspond to the transportation coordinates obtained by the calculation unit and controls the driving of the welding torch by moving the slider.

In addition, the line laser may emit a second laser beam configured to transversely cross a welding line which is spaced forward from the welding point of the welding torch, and a first laser beam configured to transversely cross a target welding line between the second laser beam and the welding point.

Further, the line laser may emit the first and second laser beams such that the first and second laser beams emitted onto a plane are parallel to each other, and centers of the first and second laser beams and the welding point are aligned in a straight line at predetermined intervals.

In addition, the detector may be configured to obtain shapes of the first and second laser beams of the line laser and apply the obtained shapes to the control unit, and the control unit may preferably control the movement of the robot and/or the mounting part, a movement of the slider, and movement times thereof to correspond to a height of a tip of the welding torch with respect to the target welding line in each position and a position of the welding torch in forward, rearward, left, and right directions through each detection data received from the detector, and controls an operation of each component to correspond to a welding implementation condition including a welding current, a welding voltage, a supply amount of an inert gas, an angle of a welding rod, and a supply speed of the welding rod.

Further, the line laser may emit a third laser beam configured to transversely cross the welding region spaced rearward from the welding torch, the detector may be configured to obtain shapes of the first, second, and third laser beams of the line laser and apply the obtained shapes to the control unit, an image database may store image information on a preset normal range of a welding shape in response to a welding result, and the control unit may control the movement of the robot and/or the mounting part, a movement of the slider, and movement times thereof to correspond to a height of a tip of the welding torch with respect to the welding line of the parent metal and a position in forward, rearward, left, and right directions through detection data received from the detector and the image database, may control an operation of each component to correspond to the welding condition including a welding current, a welding voltage, a supply amount of an inert gas, an angle of a welding rod, and a supply speed of the welding rod, may compare information on the welding result with the image information on the range of the welding shape in the image database to determine a welding defect, may calculate and store information on a correction work for the welding defect, may perform the correction work based on the information, and may perform teaching welding which reflects the welding condition for a same welding region or similar welding regions.

In addition, the robot or the slider may be weaving-driven at a preset angle in forward, rearward, left, and right directions, an inclinometer may be installed in the robot or the slider, and the control unit may receive a signal of the inclinometer to control a weaving angle of the robot or the slider with respect to a welding line depending on a welding result or a target welding line corresponding to the welding condition detected through the detector.

Meanwhile, in order to achieve the above objects, depending on the present invention, there is provided a welding method including: a preparation step (A) of providing the welding automation system using the shape of the welding region and the 3D coordinate measurement, and tracking a welding start position corresponding to shape information extracted by moving a line laser and a detector depending on position information of a welding start point and a preset start region shape of a parent metal; an alignment and information collection step (B) of adjusting a tip of a welding rod of a welding torch to be located at a preset interval height to correspond to the tracked welding start position, and continuously collecting shape information of a welding target region through the line laser and the detector by moving the tip of the welding rod of the welding torch until the tip reaches a positon of the welding start point through the line laser and the detector at the welding start point; a welding step (C) of performing welding along a target welding line from the position of the welding start point under an obtained welding condition while supplying a welding rod after igniting and preheating the welding torch from the alignment and information collection step (B), and simultaneously moving the robot and/or the mounting part and the slider to continuously measure shape information of a target welding line region at a measurement position through the line laser and the detector along the target welding line; and a finishing step (D) of stopping supply of the welding rod at a region where shape measurement information of the target welding line region through the line laser and the detector matches shape information of a preset welding end point region in a database, and performing a crater treatment by moving the tip of the welding rod upward and downward.

In addition, the welding step (C) may include: (a) collecting shape information of a welding result, in which the shape information of the welding result where welding is performed is continuously collected through the line laser and the detector; and (b) determining whether welding is normal through shape information of the obtained welding result, and the step (b) may preferably include: (b-1) stopping a welding operation of the welding torch under a determination of a welding defect; (b-2) moving the line laser and the detector to additionally collect welding region information for the welding region; (b-3) measuring a degree of the welding defect depending on the welding region information and a correction condition including a weaving work; and (b-4) correcting the welding to correspond to the measured correction condition for a welding defect region by moving the line laser, the detector, and the welding torch rearward.

Further, the step (b) may preferably include: (b-1) stopping a welding operation of the welding torch under a determination of a welding defect; (b-2) moving the line laser and the detector to additionally collect welding region information for the welding region; (b-3) measuring a degree of the welding defect depending on the welding region information and a correction condition including a weaving work; and (b-4) correcting the welding to correspond to the measured correction condition for a welding defect region by moving the line laser, the detector, and the welding torch rearward.

In addition, there is provided a welding method including: a preparation step (A′) of providing a welding automation system using a shape of a welding region and 3D coordinate measurement, in which an inclinometer is installed on a robot or a slider, and a control unit receives information of the inclinometer and the detector to control weaving driving of the robot or the slider, and tracking a welding start position corresponding to shape information extracted by moving a line laser and a detector depending on position information of a welding start point and a preset start region shape of a parent metal; an alignment and information collection step (B′) of adjusting a tip of a welding rod of a welding torch to be located at a preset interval height to correspond to the tracked welding start position, and continuously collecting shape information of a welding target region through the line laser and the detector by moving the tip of the welding rod of the welding torch until the tip reaches a position of the welding start point through the line laser and the detector at the welding start point; a welding step (C′) of performing welding along a target welding line from the position of the welding start point while supplying a welding rod and adjusting an inclination of the robot or the slider depending on an obtained welding condition after igniting and preheating the welding torch from the alignment and information collection step (B), and simultaneously moving the robot and/or the mounting part and the slider to continuously measure shape information of a target welding line region at a measurement position through the line laser and the detector along the target welding line; and a finishing step (D′) of stopping supply of the welding rod at a region where shape measurement information of the target welding line region through the line laser and the detector matches shape information of a preset welding end point region in a database, and performing a crater treatment by moving the tip of the welding rod upward and downward.

### Advantageous Effects of the Invention

depending on the above-described configuration of the present invention, the shape of the preset welding start point is found by using shape information of the welding portion extracted by the line laser and the detector, the welding is performed by tracking the position of the welding start point and the target welding region based on the position of the welding start point, and the welding is performed to the matching portion by tracking the shape portion for the preset welding end point, thereby achieving the welding automation for multiple parent metals and improving the welding accuracy.

In addition, depending on the configuration of the present invention, the double detection is performed at an interval with respect to the welding region by using one line laser and one detector, thereby minimizing the influence of flash during the welding process. Further, it is possible to accurately measure the shape of the welding region and the position of the welding point by correcting the shape of the welding region and the position of the welding point, thereby improving the accuracy of welding automation.

In addition, depending on the configuration of the present invention, it is possible to confirm the welding defects on the region where the welding was performed, and the welding defects can be corrected during the welding process, thereby improving the reliability of welding quality. Further, correction information is stored and utilized, so that it is possible to set welding condition by correcting the welding conditions for the regions where the same welding defect occurs, thereby diminishing the inconvenience related to the confirmation work and restart of the welding and reducing the working time.

### DESCRIPTION OF THE DRAWINGS

FIG. 1 is a side view schematically illustrating elements of a welding automation system using a shape of a welding region and 3D coordinate measurement depending on the present invention and an operational relationship of the elements.

FIGS. 2a and 2b are plan views schematically illustrating a relationship of information detection through a line laser for a target welding line and a laser beam emitted from the line laser.

FIG. 3 is a side view showing a welding automation system using a shape of a welding region and 3D coordinate measurement depending on a modified embodiment of the present invention.

FIGS. 4 and 5 are flowcharts for using a welding automation system that uses a shape of a welding region and 3D coordinate measurement depending on the present invention.

### BEST MODE

Terms or words used in the specification and claims should not be limited to be interpreted in general and lexical meanings, and should be construed as having meanings and concepts consistent with the technical idea of the present invention based on the principle that “the inventor can appropriately define the concept of the term to describe his or her invention in the best way”.

In addition, since embodiments shown in the specification and the configuration shown in the drawings are only preferred embodiments of the present invention that do not represent all of the technical idea of the present invention, it should be understood that various equivalents and modifications that can substitute for the embodiments at the filing of the present disclosure are within the scope of the claims of the present disclosure.

In addition, in describing the present invention, the expression ‘forward’ or ‘front side’ refers to a direction or a region in the direction to perform welding in a forward direction at a welding point where the welding is performed with a welding torch, and the expression ‘rearward’ or ‘rear side’ refers to a direction of a region in the direction opposite to the forward or the front side based on the welding point.

Further, in describing the present invention, the expression ‘upper’ is defined based on a direction in which an interval between a robot and a mounting part facing each other increases, and the expression ‘lower’ is defined based on a direction in which the interval between the robot and the mounting part facing each other decreases.

Hereinafter, preferred embodiments of the present invention will be described in detail with reference to the accompanying drawings.

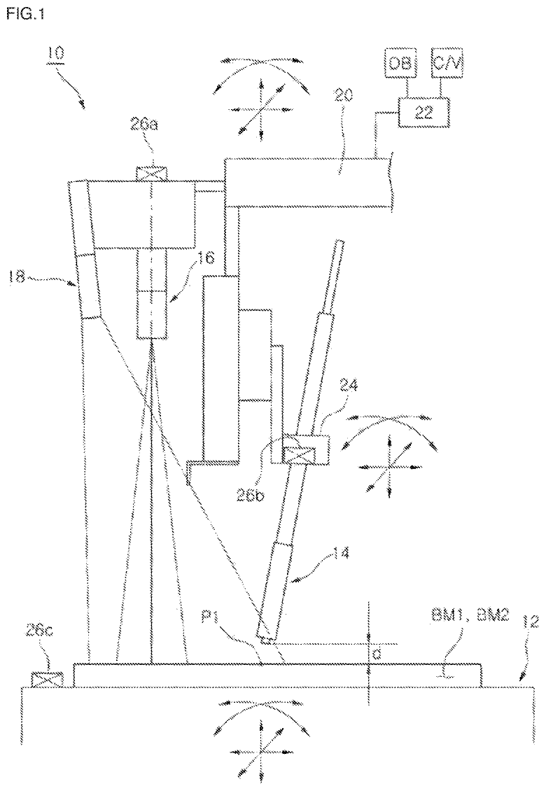

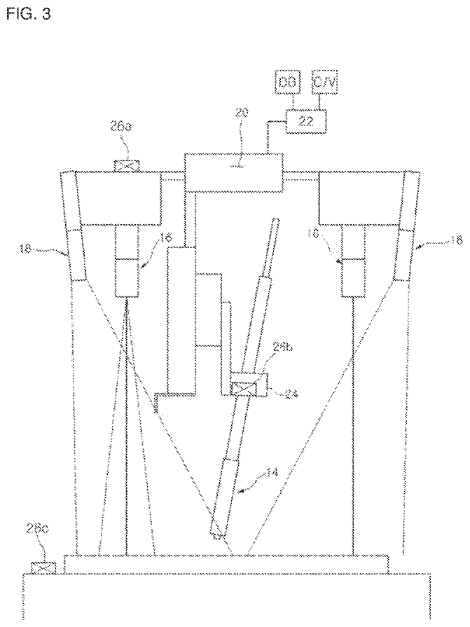

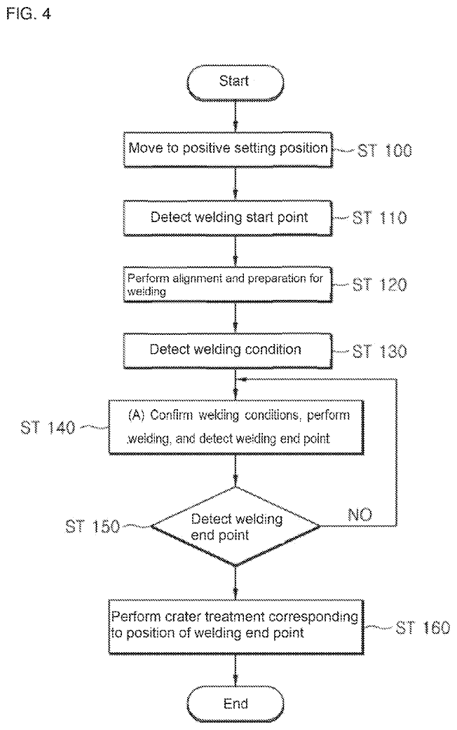

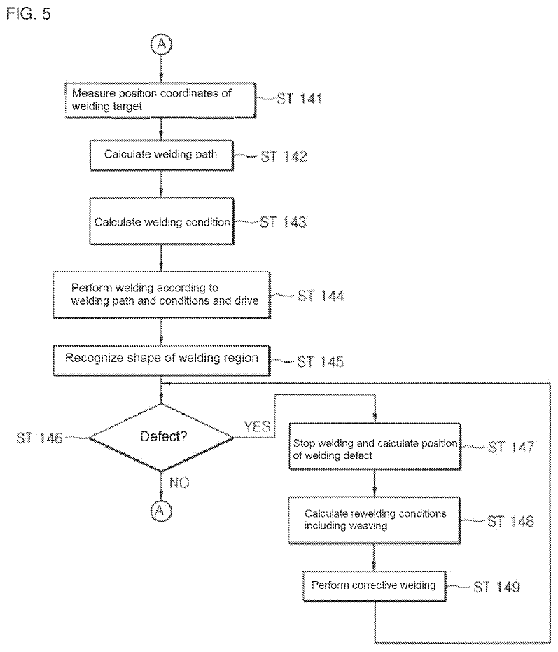

As shown in FIGS. 1 to 3, a welding automation system 10 using a shape of a welding region and 3D coordinate measurement depending on the present invention includes: a line laser 16 installed in a robot 20 to emit line-shaped laser beams L1 and L2 configured to cross a target welding line OWL which is spaced forward from a welding point P1; a detector 18 installed on the robot 20 at a preset angle to extract information so that coordinate values of the welding point P1 may be continuously measured by imaging shapes of the emitted laser beams L1 and L2; a slider 24 installed on the robot 20 on a rear side of the line laser 16 to move in upward, downward, left, and right directions by receiving a control signal; a welding torch 14 installed on the slider 24 to weld corresponding parent metals BM1 and BM2 placed on a mounting part 12 by receiving the control signal; and a control unit 22 for storing shape information on a welding start point shape and a welding inflection point or a welding end point and information on the measured coordinate values of the detector 18, and controlling a movement of the slider 24 based on a moved position of the mounting part 12 or the robot 20 such that the welding torch 14 corresponds to the start point shape and a shape of the welding inflection point or the welding end point, and the continuous measured coordinate values.

In this case, the robot 20 may be configured to receive the control signal from the control unit 22 to move upward, downward, forward, rearward, left, and right together with the line laser 16 and the detector 18 installed along the target welding line OWL of the parent metals BM1 and BM2, weaving-drive in forward, rearward, left, and right directions based on the welding point P1, and rotate to change the direction.

In addition, the slider 24 may be configured to move in the forward, rearward, left, and right directions and weaving-drive in the forward, rearward, left, and right directions from a preset reference position in the robot 20 depending on the received control signal in addition to the driving of the robot 20.

In addition, at least the robot 20 or the slider 24 among the robot 20 or the slider 24 and the mounting part 12 described above may include inclinometers 26a, 26b, and 26c for measuring an inclination in the forward, rearward, left, and right directions of the robot 20 or the slider 24 based on a preset direction reference.

Preferably, digital inclinometers may be used as the inclinometers 26a, 26b, and 26c to easily apply measurement signals thereof to the control unit 22.

In this case, one of the inclinometers 26a, 26b, and 26c installed on the mounting part 12 may be provided for accurately detecting a relative balance so that the robot 20 may maintain a predetermined interval with respect to the parent metals BM1 and BM2 installed on the mounting part 12.

In other words, in one example where the inclinometers 26a and 26c are respectively installed on the mounting part 12 and the robot 20, when the mounting part 12 is inclined, the inclinometers 26a and 26c may be provided to allow the robot 20 to move forward, rearward, left, and right while maintaining a predetermined interval with the mounting part 12 at an inclined angle of the mounting part 12, in which the robot 20 moves at an inclination to face the mounting part 12 through the inclinometer 26a relatively to the inclination of the mounting part 12 obtained through the inclinometer 26c, so that welding information on the target welding line OWL or the welding line WL may be accurately measured by the line laser 16 and the detector 18.

If the mounting part 12 is horizontally aligned and fixed, the installation of the inclinometer 26c in the mounting part 12 may be omitted, while the inclinometers 26a and 26b may measure an inclination of the robot 20 or the slider 24 based on a horizon.

Therefore, when the inclinometer is installed on one of the mounting part 12, the robot 20, and the slider 24, the inclinometer is most preferably installed on the slider 24.

Accordingly, the use of the inclinometers 26a, 26b, 26c and the control of the weaving-driving through the same may enable the welding in all postures as if the welding is performed by a worker, rather than performing the welding in a horizontal direction with respect to the parent metals BM1 and BM2.

In addition, regarding the installation of the inclinometer 26a in the robot 20, the inclinometer 26a may be installed on the line laser 16 which is installed on the robot 20. In more detail, the inclinometer 26a is preferably installed based on a first laser beam L1 vertically emitted between the mounting part 12 and the robot 20 and forward and rearward movement directions of the robot 20 which moves forward and rearward while maintaining a predetermined interval with the mounting part 12.

Accordingly, a lower tip of the welding torch 14 may be in a state capable of performing the welding on the parent metals BM1 and BM2 at a target position depending on an applied control signal at a preset interval with respect to the target welding line OWL while being guided by the slider 24.

In other words, when the mounting part 12 and the parent metals BM1 and BM2 on the mounting part 12 are fixedly located, the robot 20 may be configured to move forward, rearward, left, and right and weaving-drive in the forward, rearward, left, and right directions such that the line laser 16 may correspond along the target welding line OWL while maintaining the preset interval with respect to the mounting part 12.

In addition, the slider 24 may be configured to interwork with the forward and rearward movements of the robot 20. However, since left and right movements and upward and downward movements correspond to coordinates of the target welding line OWL of the detector 18 obtained through laser beams L1 and L2 of the line laser 16 with respect to the target welding line OWL, the slider 24 may be configured to weaving-drive in the forward, rearward, left, and right directions based on the coordinates.

Further, the above-described driving of the slider 24 may reduce a displacement of the left and right movements of the robot 20 including the line laser 16 and the detector 18 and may prevent a rapid movement so as to enable a more stable movement, so that the accuracy of the measurement for the coordinate values of the target welding line OWL by the line laser 16 and the detector 18 may be increased.

In this case, a horizontal movement of the robot 20 may be applied from the start to the end of a welding work, and may basically include a process of finding a welding start point, a process of moving for welding of another target after completing unit welding, and a process of moving upward and downward when a height or a depth of a target region of the target welding line OWL of the parent metals BM1 and BM2 is greater than a displacement of upward and downward movements of the slider 24 as described above.

The movement of the robot 20 and the movement of the slider 24 may be adopted when the size and weight of the mounting part 12 and the parent metals BM1 and BM2 are relatively greater than the size and weight of the robot 20 including the slider 24 equipped with the line laser 16, the detector 18, and the welding torch 14.

In contrast, when the size and weight of the mounting part 12 including the parent metals BM1 and BM2 are smaller than those of the above-described robot 20, and the operation of the mounting part 12 is easier, the mounting part 12 may be configured to move rearward or forward and slide in left and right directions instead of driving the above-described robot 20. In this case, the above-described slider 24 may move in left and right directions and upward and downward directions to allow the welding torch 14 to correspond to the coordinate values of the target welding line OWL of the detector 18 through the laser beams L1 and L2 of the line laser 16 for the target welding line OWL corresponding to the driving of the mounting part 12.

The above-described mounting part 12 and the robot 20 may relatively move in forward, rearward, left, and right directions while maintaining a predetermined reference distance from each other, and the slider 24 may move depending on the measured coordinate values of the detector 18 with respect to the height displacement and the left and right displacements between the parent metals BM1 and BM2 with respect to the target welding line OWL.

This is to solve the problem occurring in the related art, which is caused by simultaneously performing the welding to the parent metal and measurement of the coordinate values of the target welding line in a state in which the line laser, the detector and the welding torch are mounted on the robot.

For example, the robot of the related art performs the moving and welding along the target welding line while maintaining the preset interval of the welding torch. In this case, the line laser and the detector move along with the trajectory of the welding torch as the robot moves, and measure the coordinate values of the target welding line.

That is, depending on the related art, the line laser and the detector measure the coordinate values while moving in forward, rearward, upward, downward, left, and right directions, and data of the measured coordinate values of the target welding line has to be converted based on the current position of the welding torch, but the calculation is difficult.

In other words, depending on the related art for measuring the coordinate values of the target welding line, there is the possibility of error and it is difficult to convert the measured coordinate value into data corresponding to the welding torch. In addition, the flash generated during a welding process of the welding torch may distort the laser beam of the line laser, thereby causing measurement errors. Further, it is difficult to accurately measure the welding amount and the welding time for the target welding line, so the related art cannot be actually applied to welding automation.

In this regard, depending on the present invention, positions of the line laser 16 and the detector 18 can be stably moved to accurately measure the coordinate value data for the target welding line OWL. In addition, the welding torch 14 can accurately perform the welding work corresponding to the coordinate value data for the target welding line OWL through the slider 24.

For this reason, the slider 24 is suitable for the weaving driving between the robot 20 and the slider 24. Regarding the installation of inclinometers 26a and 26b, the inclinometer 26b for the slider 24 is installed to control the inclination of the slide 24.

In the above configuration, the welding torch 14 for TIG (tungsten inert gas) welding will be described as an example of a welding torch in the description of the present invention, but the present invention is not limited to the welding torch for the TIG welding. Various welding torches used for arc welding, oxygen welding, C02 welding and MIG (metallic inert gas arc welding) can be used in the present invention.

That is, the welding torch 14 of each embodiment may be modified in various forms so far as the welding implementation condition for the corresponding parent metals BM1 and BM2 can be controlled in response to the control signal of the control unit 22 and the welding work can be controlled.

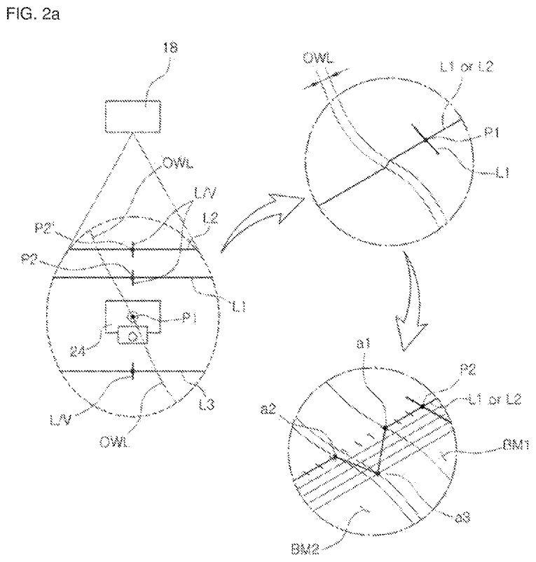

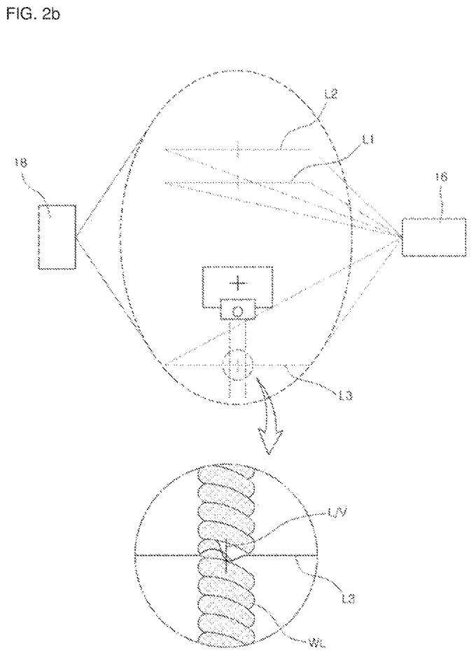

Meanwhile, as shown in FIGS. 1 and 2a, the line laser 16 in the above configuration may be configured to emit a line-shaped transverse first laser beam L1 intersecting across the target welding line OWL located at a predetermined interval from the welding point P1 where welding is performed by the welding torch 14 and a line-shaped transverse second laser beam L2 intersecting across the target welding line OWL located forward at a predetermined interval from the first laser beam L1 and parallel to the first laser beam L1.

In this manner, the first and second laser beams L1 and L2 are arranged in parallel to each other in order to allow the detector 18 to doubly measure information, such as coordinate values of the target welding line, through the shapes of the emitted first and second laser beams L1 and L2.

In other words, the detector 18 may measure a line shape of the target welding line OWL located at a predetermined interval from the welding point P1 through the second laser beam L2 emitted at a foremost portion based on the welding point P1 to measure information such as a coordinate value of a corresponding position, a welding amount at a position of the coordinate value, and a time required for the welding together with the control unit 22.

In addition, the detector 18 may measure the line shape of the welding line OWL through the first laser beam L1 located at predetermined intervals from the second laser beam L2 and the welding point P1 to measure the coordinate value of the corresponding position, the welding amount at the position of the coordinate value, and the time required for the welding together with the control unit 22, so that the detector 18 may compare a measurement result with the information measured through the second laser beam L2 located on a front side together with the control unit 22 so as to allow a user to check an error or a correction state thereof.

Above all, double calculation of the welding information including the coordinate values of the welding point P1 through the first and second laser beams L1 and L2 at predetermined intervals is performed to compensate for detection errors or detection omission of the welding information at the corresponding region due to distortion of the emitted first or second laser beams L1 or L2 caused by a flash generated at the welding point P1 when the detector 18 measures the coordinate values of the target welding line OWL at the corresponding region through the first and second laser beams L1 and L2.

In this case, although not shown in the drawings, it is natural that two line lasers 16 for respectively emitting the first laser beam L1 and the second laser beam L2 may be provided to the robot 20. In this case, it is preferable to vertically emit each of the first and second laser beams L1 and L2 between the robot 20 and the mounting part 12.

Meanwhile, the line laser 16 may simultaneously emit two beams, which are the first and second laser beams L1 and L2, from one beam source with respect to the target welding line OWL. In this case, one of the first and second laser beams L1 and L2 may be vertically emitted between the robot 20 and the mounting part 12, and the other may be emitted at a preset angle with respect to the one that is vertically emitted.

In this case, one of the first and second laser beams L1 and L2 that is vertically emitted may maintain a preset interval with respect to the welding point P1 of the welding torch 14, in which the first laser beam L1 which is closest to the welding torch 14 may be vertically emitted between the robot 20 and the mounting part 12.

In addition, when one or more of the first and second laser beams L1 and L2 are inclined with respect to a vertical direction between the robot 20 and the mounting part 12, a distance between the first and second laser beams L1 and L2 may be increased or decreased as an interval between the robot 20 and the mounting part 12 is increased or decreased, and such a variation in the distance may be used as information for checking the interval between the robot 20 and the mounting part 12 through the detector 18.

Further, the line laser 16 may simultaneously emit a vertical laser beam L/V which is configured to longitudinally cross a longitudinal center of each of the first and second laser beams L1 and L2.

The vertical laser beam L/V may check an alignment error through a control value and a measurement value by performing measurement on a plane while the centers of the first and second laser beams L1 and L2 and the welding point P1 for the welding torch 14 are aligned in a straight line.

In this case, preferably, the vertical laser beam L/V is relatively short as compared with a length of each of the first and second laser beams L1 and L2.

That is, in a state where the welding point P1 and the centers of the first and second laser beams L1 and L2 are controlled to be in the straight line, when measured values of the welding point P1 and the centers of the first and second laser beams L1 and L2 are not present in the straight line, the vertical laser beam L/V may be used to identify misalignment of the line laser 16 and the welding torch 14 to prevent measurement errors. In addition, the target welding line OWL may be used to measure a transverse separation distance with respect to the centers of the first and second laser beams L1 and L2 so as to provide a basis for checking or correcting the measured value.

In other words, each of the centers P2 and P2′ of the emitted laser beams where the first and second laser beams L1 and L2 and the vertical laser beam L/V in transverse and longitudinal directions meet each other may be in a straight line with the weld point P1 when the target welding line OWL is a straight line, and the robot 20 moves forward along a straight line by a distance equal to or greater than an interval between the second laser beam L2 and the welding point P1.

In addition, the line laser 16 may be located on a lateral side with respect to a forward direction of the robot 20. In this case, when the vertical laser beam L/V is emitted to a position on a plane at the same height as the welding point P1 of the welding torch 14, the vertical laser beam L/V is placed in a straight line with respect to the forward direction of the robot 20 and the welding point P1, so that the vertical laser beam L/V may be adjusted to be in a straight line to form a condition of setting a height of the welding torch 14 with respect to the parent metals BM1 and BM2.

The line laser 16 may emit a third laser beam L3, which is configured to cross the welding line WL, to the welding line WL where the welding is performed by the welding torch 14 as well as the target welding line OWL that is a welding target.

In this case, the line laser 16 may be installed on the robot 20 separately from configurations for emitting the first and second laser beams L1 and L2, or may be located on the lateral side with respect to the forward direction of the robot 20 to emit the third laser beam L3 as well as the first and second laser beams L1 and L2.

Meanwhile, the detector 18 may calculate a welding condition such as the coordinates of the target welding line OWL, a width and a depth of the welding target at the coordinates, and a welding amount through an image obtained by imaging the first to third laser beams L1, L2, and L3 in the transverse and longitudinal directions and vertical laser beams L/V thereof at a preset angle, may store the calculated welding condition in the control unit 22, and may allow the welding torch 14 to move correspondingly to the coordinates, allow the left and right movements to be performed correspondingly to the width of the welding target and the welding amount, and allow a weaving work to be performed at various angles in a width direction correspondingly to the welding time and the welding condition in a future process of the welding through the welding torch 14.

In this case, as shown in FIG. 2a, coordinate values of a welding target region may be calculated by the detector 18, in which an interval between the welding point P1 of the welding torch 14 and an emission center P2, which are located in a straight line, upon the emission may be a preset interval, the interval may be recognized as a distance of the movement of the robot 20 and/or the mounting part 12, and each of inflection points a1, a2, and a3 of the first or second laser beam L1 or L2 in the transverse direction may be converted into a separation distance and a depth in the transverse direction based on the emission center P2 on a position of a plane of the parent metals BM1 and BM2 so as to be recognized as a volume corresponding to the welding amount through a correlation between the corresponding position and a moving amount of the robot 20.

Accordingly, the detector 18 may allow the control unit 22 to calculate a sectional area of the corresponding welding target region based on the coordinate values of each of the inflection points a1, a2, and a3 so as to provide a welding condition for performing the following welding by the welding torch 14.

In addition, the detector 18 preferably provides a captured image of the welding target region to allow the control unit 22 to determine a region smeared with paint or a region with rust in the welding target region of the parent metals BM1 and BM2.

Further, although not shown in the drawings, the detector 18 may further include a probe (not shown) for determining the presence or absence of the paint or the rust by making electrical contact with the welding target region.

In addition, the detector 18 may be configured to detect a welding shape with respect to the third laser beam L3 corresponding to a welding region and apply the detected welding shape to the control unit 22.

Accordingly the control unit 22 may determine a welding defect in comparison with pre-stored data on a range of a shape of a bead in the welding region detected by the detector 18.

In addition, the detector 18 may be divided into one for determining the first and second laser beams L1 and L2 and one for determining the third laser beam L3 so as to be separately installed.

The control unit 22 corresponding to the above configuration may preferably control a movement and a moving time of the robot 20 and/or the mounting part 12 with respect to a height of a tip of the welding torch 14 and a positon of the welding torch 14 in the forward, rearward, left, and right directions based on the target welding line OWL of the parent metals BM1 and BM2 through each detection data received from the detector 18, and control various welding conditions including a welding current, a welding voltage, a supply amount of an inert gas, an angle of a welding rod WR, and a supply speed of welding rod WR.

In addition, the control unit 22 may preferably store information on the welding region including the target welding line OWL, information on the welding process of the welding torch 14 and a welding result thereof, and information on a correction work including a weaving treatment for a welding defect in the welding result, and perform teaching welding which reflects the welding condition for the same welding region or similar welding regions based on the above information.

In particular, the control unit 22 depending on the present invention may store preset images indicating a welding start point and a welding end point in a database DB before starting the welding for the parent metals BM1 and BM2, may compare the stored preset images with the image obtained through the line laser 16 and the detector 18 to track a position of the welding start point and perform the welding, and may determine a position of the welding end point to finish the welding.

In addition, the control unit 22 may store data on coordinates of each position of the welding start point in the database DB in order to rapidly move the robot 20 with respect to the parent metal BM1 or BM2 which is preset and placed on the mounting part 12, or a position of a welding start point of the other parent metal BM1 or BM2 that continues from the welding end point.

Accordingly, the control unit 22 may move the robot 20 to a position corresponding to the welding start point, may extract a shape of the corresponding welding target region through the line laser 16 and the detector 18, may locate the welding torch 14 to start the welding at a correct position of the welding start point as compared with the shape of the welding start point stored in the database DB, may perform the welding in consideration of welding conditions such as a height of the welding torch 14, a welding amount, a welding width, a welding time, and a welding angle, and may simultaneously track the welding end point to finish the welding at a corresponding position.

Meanwhile, FIG. 2c shows a configuration in which a separate line laser 16 and a separate detector 18 for detecting a line-shaped beam emitted from the line laser 16 are additionally installed for a region where the welding is performed by the welding torch 14 in the configuration of FIG. 2a so as to determine a defect of the region where the welding is performed, and detection information thereof is applied to the control unit 22 to allow the control unit 22 to perform the correction work and the corresponding teaching welding in a process of the welding work.

Hereinafter, a welding process by using the welding automation system using a shape of a welding region and 3D coordinate measurement depending on the present invention as described above will be described.

First, the control unit 22 of the welding automation system 10 depending on the present invention may move the robot 20 and/or the mounting part 12 to a randomly set position so that the welding torch 14 of the robot 20 may be located at a sufficient interval with respect to preset positions of the parent metals BM1 and BM2 on the mounting part 12 (ST100).

In such a process, the control unit 22 may measure the shape of the welding target region by using the line laser 16 and the detector 18, and may compare shape data obtained therefrom with shape data of the position of the welding start point stored in the database DB to detect the coordinates of the welding start point (ST110).

Thereafter, the control unit 22 may adjust the height of the welding torches 14 with respect to the parent metals BM1 and BM2 to be a preset height through the line laser 16 and the detector 18 while checking the alignment of the line laser 16, the detector 18, and the welding torch 14, may check and re-check the position of the welding start point through one beam that first makes contact with a designated position of the welding start point as the robot 20 or the mounting part 12 continuously moves and the other beam among the first and second laser beams L1 and L2 of the line laser 16, and may continuously obtain welding information on a region of the target welding line OWL, in which the above process constitutes a welding preparation step (A) of performing alignment and obtaining information until the tip of the welding rod WR of the welding torch 14 corresponds to the position of the welding start point (ST120).

In this case, the control unit 22 may allow the emission center P2 to correspond to the welding start point by using the line laser 16, and may move the robot 20 and/or mounting part 12 to detect the welding conditions including a shape, coordinate values, and a welding amount for the target welding line OWL from the tip of the welding torch 14, that is, the tip of the welding rod WR to a position corresponding to the welding start point in order to detect the welding conditions including a direction of progress of the target welding line OWL without immediately starting the welding at the welding start point (ST130).

Thereafter, the control unit 22 may perform a welding implementation step (B) of performing the welding corresponding to the welding conditions through the welding torch 14 when the tip of the welding torch 14 is located at the welding start point, detecting a preset position of the welding end point, and performing the welding along the target welding line OWL to the welding end point (ST140).

In this case, the control unit 22 may perform a process of controlling the welding torch 14 to perform the welding corresponding to a temporarily welded region between the parent metals BM1 and BM2 through the welding information obtained through the detector 18.

The above welding implementation process includes: measuring continuous position coordinates for the welding target region after the welding start point (ST141); calculating a welding path through the measurement (ST142); continuously calculating the welding conditions such as the welding depth, a welding volume, and an angular condition of the welding rod for each region of the welding path (ST143); and moving the slider 24 with respect to the welding path including the calculated welding conditions (ST144).

In addition, the control unit 22 may recognize the shape of the welding performed on the welding region through the detector 18 (ST145) to determine whether the welding is normal (ST146).

The control unit 22 may continuously perform the above process, and when it is determined as a welding defect during the implementation process, the control unit 22 may stop performing the welding and simultaneously calculate a position of the welding defect (ST147).

Then, the control unit 22 may set the welding conditions through the first and second laser beams L1 and L2 by moving the robot 20 and/or the mounting part 12 rearward, may recalculate rewelding conditions while re-checking whether there is paint or rust on the corresponding region through the detector 18, and may calculate corresponding weaving conditions and the rewelding conditions including adjustment of an angle of the welding rod WR (ST148)

Thereafter, the control unit 22 may obtain information on the rewelding conditions including imaging information of the detector 18 while performing a rewelding work and checking the welding process, and may include a correction step (b) of storing data including the weaving conditions while performing an inspection process, reflecting the correction conditions (teaching conditions) and correction data into subsequent welding conditions for the same welding target region or similar welding target regions so as to perform rewelding while preventing repeated welding defects through (ST149).

In addition, the control unit 22 may further include a correction step (b) of performing a weaving work for the welding defect while inspecting the region welded during the welding step (B), correcting the corresponding welding conditions, storing correction data, and reflecting the welding conditions for the same welding target region or similar welding target regions.

In the above process of the welding step (B), the control unit 22 may continuously detect the preset welding end point through the detector 18 (ST150), and may terminate the welding work by performing a finishing step (C) of receiving a detection signal for the welding end point, stopping the supply of the welding rod of the welding torch 14 to the welding end point, and performing a crater treatment by moving the tip of the welding rod upward and downward (ST160).

In addition, the control unit 22 may further include a correction step (b) of performing a weaving work for the welding defect while inspecting the region welded during the welding step (B), correcting the corresponding welding conditions, storing correction data, and reflecting the welding conditions for the same welding target region or similar welding target regions.

### DESCRIPTION OF REFERENCE NUMERALS

| | |
|---|---|
| BM1, BM2: Parent metal | P1: Welding point |
| L1, L2, L3: Laser beam | WL: Welding line |
| WR: Welding rod | DB: Database |
| 10: Welding automation system | 12: Mounting part |
| 14: Welding torch | 16: Line laser |
| 18: Detector | 20: Robot |
| 22: Control unit | 24: Slider |
| 26a, 26b, 26c: Inclinometer | |

1. A welding automation system using a shape of a welding region and 3D coordinate measurement, the welding automation system comprising:
a welding torch installed in a robot to weld a parent metal fixed on a mounting part depending on a control signal;
a line laser for emitting a laser beam having a straight line shape to a welding line region which is spaced apart from a welding point of the welding torch;
a detector for imaging and detecting the shape of the line-shaped laser beam emitted to a welding target region at a preset angle; and
a control unit for receiving information from the detector to control transportation of the robot and driving of the welding torch along the welding region such that the welding torch corresponds to the welding region,
wherein:
the welding torch is installed on a slider which is driven in upward, downward, left, and right directions with respect to the robot,
the control unit includes:
a database for storing preset shape information on a welding start point region and a welding end point region of the parent metal; and
a calculation unit for determining whether welding region shape information received from the detector matches the preset shape information in the database, while obtaining a welding condition including transportation coordinates of the welding torch, a welding depth, a welding width, a welding amount, and a welding time such that the welding torch corresponds to the welding region shape information of the detector at a preset interval, and
the control unit controls a movement of the robot and/or the mounting part to correspond to the transportation coordinates obtained by the calculation unit and controls the driving of the welding torch by moving the slider.

2. The welding automation system of claim 1, wherein the line laser emits:
a second laser beam configured to transversely cross a welding line which is spaced forward from the welding point of the welding torch, and
a first laser beam configured to transversely cross a target welding line between the second laser beam and the welding point.

3. The welding automation system of claim 2, wherein the line laser emits the first and second laser beams such that:
the first and second laser beams emitted onto a plane are parallel to each other, and
centers of the first and second laser beams and the welding point are aligned in a straight line at predetermined intervals.

4. The welding automation system of claim 3, wherein
the detector is configured to obtain shapes of the first and second laser beams of the line laser and apply the obtained shapes to the control unit, and
the control unit controls:
the movement of the robot and/or the mounting part, a movement of the slider, and movement times thereof to correspond to a height of a tip of the welding torch with respect to the target welding line in each position and a position of the welding torch in forward, rearward, left, and right directions through each detection data received from the detector, and
an operation of each component to correspond to a welding implementation condition including a welding current, a welding voltage, a supply amount of an inert gas, an angle of a welding rod, and a supply speed of the welding rod.

5. The welding automation system of claim 3, wherein;
the line laser emits a third laser beam configured to transversely cross the welding region spaced rearward from the welding torch,
the detector is configured to obtain shapes of the first, second, and third laser beams of the line laser and apply the obtained shapes to the control unit,
an image database stores image information on a preset normal range of a welding shape in response to a welding result, and
the control unit:
controls the movement of the robot and/or the mounting part, a movement of the slider, and movement times thereof to correspond to a height of a tip of the welding torch with respect to the welding line of the parent metal and a position in forward, rearward, left, and right directions through detection data received from the detector and the image database,
controls an operation of each component to correspond to the welding condition including a welding current, a welding voltage, a supply amount of an inert gas, an angle of a welding rod, and a supply speed of the welding rod,
compares information on the welding result with the image information on the range of the welding shape in the image database to determine a welding defect,
calculates and stores information on a correction work for the welding defect,
performs the correction work based on the information, and
performs teaching welding which reflects the welding condition for a same welding region or similar welding regions.

6. The welding automation system of claim 1, wherein:
the robot or the slider is weaving-driven at a preset angle in forward, rearward, left, and right directions, an inclinometer is installed in the robot or the slider, and
the control unit receives a signal of the inclinometer to control a weaving angle of the robot or the slider with respect to a welding line depending on a welding result or a target welding line corresponding to the welding condition detected through the detector.

7. A welding method comprising:
a preparation step of:
providing a welding automation system using a shape of a welding region and 3D coordinate measurement of claim 1, and
tracking a welding start position corresponding to shape information extracted by moving a line laser and a detector depending on position information of a welding start point and a preset start region shape of a parent metal;
an alignment and information collection step of:
adjusting a tip of a welding rod of a welding torch to be located at a preset interval height to correspond to the tracked welding start position, and
continuously collecting shape information of a welding target region through the line laser and the detector by moving the tip of the welding rod of the welding torch until the tip reaches a position of the welding start point through the line laser and the detector at the welding start point;
a welding step of:
performing welding along a target welding line from the position of the welding start point under an obtained welding condition while supplying a welding rod after igniting and preheating the welding torch from the alignment and information collection step, and
simultaneously moving the robot and/or the mounting part and the slider to continuously measure shape information of a target welding line region at a measurement position through the line laser and the detector along the target welding line; and
a finishing step of:
stopping supply of the welding rod at a region where shape measurement information of the target welding line region through the line laser and the detector matches shape information of a preset welding end point region in a database, and
performing a crater treatment by moving the tip of the welding rod upward and downward.

8. The welding method of claim 7, wherein the welding includes:
collecting shape information of a welding result, in which the shape information of the welding result where welding is performed is continuously collected through the line laser and the detector; and
determining whether welding is normal through shape information of the obtained welding result, including:
stopping a welding operation of the welding torch under a determination of a welding defect;
moving the line laser and the detector to additionally collect welding region information for the welding region;
measuring a degree of the welding defect depending on the welding region information and a correction condition including a weaving work; and
correcting the welding to correspond to the measured correction condition for a welding defect region by moving the line laser, the detector, and the welding torch rearward.

9. A welding method comprising:
a preparation step of:
providing a welding automation system using a shape of a welding region and 3D coordinate measurement of claim 6, and
tracking a welding start position corresponding to shape information extracted by moving a line laser and a detector depending on position information of a welding start point and a preset start region shape of a parent metal;
an alignment and information collection step of:
adjusting a tip of a welding rod of a welding torch to be located at a preset interval height to correspond to the tracked welding start position, and
continuously collecting shape information of a welding target region through the line laser and the detector by moving the tip of the welding rod of the welding torch until the tip reaches a position of the welding start point through the line laser and the detector at the welding start point;
a welding step of:
performing welding along a target welding line from the position of the welding start point while supplying a welding rod and adjusting an inclination of the robot or the slider depending on an obtained welding condition after igniting and preheating the welding torch from the alignment and information collection step (B), and
simultaneously moving the robot and/or the mounting part and the slider to continuously measure shape information of a target welding line region at a measurement position through the line laser and the detector along the target welding line; and
a finishing step of:
stopping supply of the welding rod at a region where shape measurement information of the target welding line region through the line laser and the detector matches shape information of a preset welding end point region in a database, and
performing a crater treatment by moving the tip of the welding rod upward and downward.

10. The welding automation system of claim 2, wherein:
the robot or the slider is weaving-driven at a preset angle in forward, rearward, left, and right directions, an inclinometer is installed in the robot or the slider, and
the control unit receives a signal of the inclinometer to control a weaving angle of the robot or the slider with respect to a welding line depending on a welding result or a target welding line corresponding to the welding condition detected through the detector.

11. A welding method comprising:
a preparation step of:
providing a welding automation system using a shape of a welding region and 3D coordinate measurement of claim 2, and
tracking a welding start position corresponding to shape information extracted by moving a line laser and a detector depending on position information of a welding start point and a preset start region shape of a parent metal;
an alignment and information collection step of:
adjusting a tip of a welding rod of a welding torch to be located at a preset interval height to correspond to the tracked welding start position, and
continuously collecting shape information of a welding target region through the line laser and the detector by moving the tip of the welding rod of the welding torch until the tip reaches a position of the welding start point through the line laser and the detector at the welding start point;
a welding step of:
performing welding along a target welding line from the position of the welding start point under an obtained welding condition while supplying a welding rod after igniting and preheating the welding torch from the alignment and information collection step, and
simultaneously moving the robot and/or the mounting part and the slider to continuously measure shape information of a target welding line region at a measurement position through the line laser and the detector along the target welding line; and
a finishing step of:
stopping supply of the welding rod at a region where shape measurement information of the target welding line region through the line laser and the detector matches shape information of a preset welding end point region in a database, and
performing a crater treatment by moving the tip of the welding rod upward and downward.

12. The welding automation system of claim 3, wherein:
the robot or the slider is weaving-driven at a preset angle in forward, rearward, left, and right directions, an inclinometer is installed in the robot or the slider, and
the control unit receives a signal of the inclinometer to control a weaving angle of the robot or the slider with respect to a welding line depending on a welding result or a target welding line corresponding to the welding condition detected through the detector.

13. A welding method comprising:
a preparation step of:
providing a welding automation system using a shape of a welding region and 3D coordinate measurement of claim 3, and
tracking a welding start position corresponding to shape information extracted by moving a line laser and a detector depending on position information of a welding start point and a preset start region shape of a parent metal;
an alignment and information collection step of:
adjusting a tip of a welding rod of a welding torch to be located at a preset interval height to correspond to the tracked welding start position, and
continuously collecting shape information of a welding target region through the line laser and the detector by moving the tip of the welding rod of the welding torch until the tip reaches a position of the welding start point through the line laser and the detector at the welding start point;
a welding step of:
performing welding along a target welding line from the position of the welding start point under an obtained welding condition while supplying a welding rod after igniting and preheating the welding torch from the alignment and information collection step, and
simultaneously moving the robot and/or the mounting part and the slider to continuously measure shape information of a target welding line region at a measurement position through the line laser and the detector along the target welding line; and
a finishing step of:
stopping supply of the welding rod at a region where shape measurement information of the target welding line region through the line laser and the detector matches shape information of a preset welding end point region in a database, and
performing a crater treatment by moving the tip of the welding rod upward and downward.

14. The welding automation system of claim 4, wherein:
the robot or the slider is weaving-driven at a preset angle in forward, rearward, left, and right directions, an inclinometer is installed in the robot or the slider, and
the control unit receives a signal of the inclinometer to control a weaving angle of the robot or the slider with respect to a welding line depending on a welding result or a target welding line corresponding to the welding condition detected through the detector.

15. A welding method comprising:
a preparation step of:
providing a welding automation system using a shape of a welding region and 3D coordinate measurement of claim 4, and
tracking a welding start position corresponding to shape information extracted by moving a line laser and a detector depending on position information of a welding start point and a preset start region shape of a parent metal;
an alignment and information collection step of:
adjusting a tip of a welding rod of a welding torch to be located at a preset interval height to correspond to the tracked welding start position, and
continuously collecting shape information of a welding target region through the line laser and the detector by moving the tip of the welding rod of the welding torch until the tip reaches a position of the welding start point through the line laser and the detector at the welding start point;
a welding step of:
performing welding along a target welding line from the position of the welding start point under an obtained welding condition while supplying a welding rod after igniting and preheating the welding torch from the alignment and information collection step, and
simultaneously moving the robot and/or the mounting part and the slider to continuously measure shape information of a target welding line region at a measurement position through the line laser and the detector along the target welding line; and
a finishing step of:
stopping supply of the welding rod at a region where shape measurement information of the target welding line region through the line laser and the detector matches shape information of a preset welding end point region in a database, and
performing a crater treatment by moving the tip of the welding rod upward and downward.

16. The welding automation system of claim 5, wherein:
the robot or the slider is weaving-driven at a preset angle in forward, rearward, left, and right directions, an inclinometer is installed in the robot or the slider, and
the control unit receives a signal of the inclinometer to control a weaving angle of the robot or the slider with respect to a welding line depending on a welding result or a target welding line corresponding to the welding condition detected through the detector.

17. A welding method comprising:
a preparation step of:
providing a welding automation system using a shape of a welding region and 3D coordinate measurement of claim 5, and
tracking a welding start position corresponding to shape information extracted by moving a line laser and a detector depending on position information of a welding start point and a preset start region shape of a parent metal;
an alignment and information collection step of:
adjusting a tip of a welding rod of a welding torch to be located at a preset interval height to correspond to the tracked welding start position, and
continuously collecting shape information of a welding target region through the line laser and the detector by moving the tip of the welding rod of the welding torch until the tip reaches a position of the welding start point through the line laser and the detector at the welding start point;
a welding step of:
performing welding along a target welding line from the position of the welding start point under an obtained welding condition while supplying a welding rod after igniting and preheating the welding torch from the alignment and information collection step, and
simultaneously moving the robot and/or the mounting part and the slider to continuously measure shape information of a target welding line region at a measurement position through the line laser and the detector along the target welding line; and
a finishing step of:
stopping supply of the welding rod at a region where shape measurement information of the target welding line region through the line laser and the detector matches shape information of a preset welding end point region in a database, and
performing a crater treatment by moving the tip of the welding rod upward and downward.
